(19) United States
(12) Patent Application Publication
(10) Pub. No.: US 2009/0168290 A1
(43) Pub. Date: Jul. 2, 2009

(54) BATTERY CLIP WTIH INTEGRATED MICROPROCESSOR RESET SWITCH AND METHOD OF OPERATING

(76) Inventors: Patrick Dale Riedlinger, Independence, OR (US); Daniel Warren Evans, Tualatin, OR (US); John Pershing Steele, JR., Beaverton, OR (US)

Correspondence Address: General Electric Company;GE Global Patent Operation, PO Box 861, 2 Corporate Drive, Suite 648, Shelton, CT, 06484, US

(21) Appl. No.: 11/966,355

(22) Filed: Dec. 28, 2007

(51) Int. Cl. H02H 9/00; H02H 1/00

(52) U.S. Cl. 361/220

(57) ABSTRACT

Disclosed is a battery clip for resetting an electronic device when one or more batteries are removed from a battery compartment. The battery compartment may be included in, or coupled with, the electronic device. A method of operating the battery clip is also described.

### BACKGROUND

1. Field of the Invention

The field of the invention relates to low-power electronic devices generally, and more particularly to certain new and useful advances in battery-powered electronic devices, of which the following is a specification, reference being had to the drawings accompanying and forming a part of the same.

2. Discussion of Related Art

When an electronic device, such as a smoke detector, a motion detector, a door sensor, a window sensor, and the like, has its batteries changed, residual battery energy stored in one or more capacitors can keep the electronic device's microprocessor running. This is problematic because an operating state or function of the microprocessor that required removal of the one or more batteries typically will not be reset if one or more fresh batteries are inserted before the residual battery energy dissipates. Resetting the electronic device's microprocessor is necessary to properly reset all variables required to detect a low battery condition so that the electronic device, with its batteries replaced, can run without failure until another low battery condition is detected.

A user can request a service call to reset the electronic device; but this is costly. Alternatively, the user can wait, anywhere from a few minutes to about several hours, until the one or more capacitors run out of residual battery energy; but this length of time multiplies when the user is servicing tens or hundreds of electronic devices. As a third option, a watchdog circuit can be incorporated into the electronic device to reset the microprocessor. In simplest form, a watchdog circuit is a timer that generates a reset signal after a predetermined period of microprocessor inactivity. A more complicated watchdog circuit may include a voltage monitor and a timer.

A solution is needed that ensures safe and quick reset of an electronic device, whenever one or more batteries that provide power to a microprocessor of the electronic device are removed.

### SUMMARY

The above-referenced drawbacks and disadvantages of previous electronic devices are overcome by embodiments—described, illustrated, and claimed herein—of a battery clip that is configured to automatically and safely force reset of an electronic device whenever one or more batteries that provide power to a microprocessor of the electronic device are replaced, and by embodiments of a method of operating the battery clip.

When properly implemented, embodiments of the battery clip can prevent damage to one or more components of the electronic device; can eliminate the need to wait for a residual battery energy stored in one or more capacitors to dissipate naturally; and can reduce service calls.

Other features and advantages of the claimed invention will become apparent by reference to the following descriptions taken in connection with the accompanying drawings.

### BRIEF DESCRIPTION OF THE DRAWINGS

Reference is now made briefly to the accompanying drawings, in which:

FIG. 1 is a diagram showing a first position of an embodiment of a battery clip when a battery is absent from a battery compartment;

FIG. 2 is a diagram showing a second position of the embodiment of the battery clip of FIG. 1 when a battery is present in the battery compartment;

FIG. 3 is a flowchart illustrating an embodiment of a method of moving a battery relative to a battery compartment to automatically reset an electronic device;

FIG. 4 is a cross-sectional view, taken along the line A-A′ in FIG. 2, of a material that comprises an embodiment of the battery clip; and

FIG. 5 is also a cross-sectional view, taken along the line A-A′ in FIG. 2, of an electrically conductive material plated with a non-corrosive material, that comprises another embodiment of the battery clip.

Like reference characters designate identical or corresponding components and units throughout the several views, which are not to scale unless otherwise indicated.

### DETAILED DESCRIPTION

Specific configurations and arrangements of the claimed invention, discussed below with reference to the accompanying drawings, are for illustrative purposes only. Other configurations and arrangements that are within the purview of a skilled artisan can be made without departing from the spirit and scope of the appended claims. For example, while some embodiments of the invention are herein described with reference to smoke detectors, motion detectors, door sensors, window sensors, and the like, a skilled artisan will recognize that embodiments of the invention can be implemented in any type of low-power, battery-operated, electronic device.

For brevity's sake, it is impossible to list herein an example of every other type of low-power, battery-operated, electronic device in which an embodiment of the claimed battery clip may be implemented. Some non-limiting examples of such other devices, however, include: a laptop computer, a handheld computer, a wireless telephone handset, a handheld entertainment device, a digital camera, a digital clock, a navigation device, a radio-controlled toy, a robotic device, a military communications device, a military weapons system, a medical device, a scientific device, a life safety device, a security device, and so forth.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

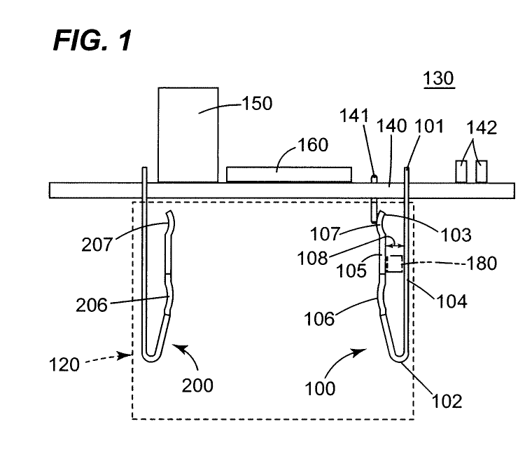

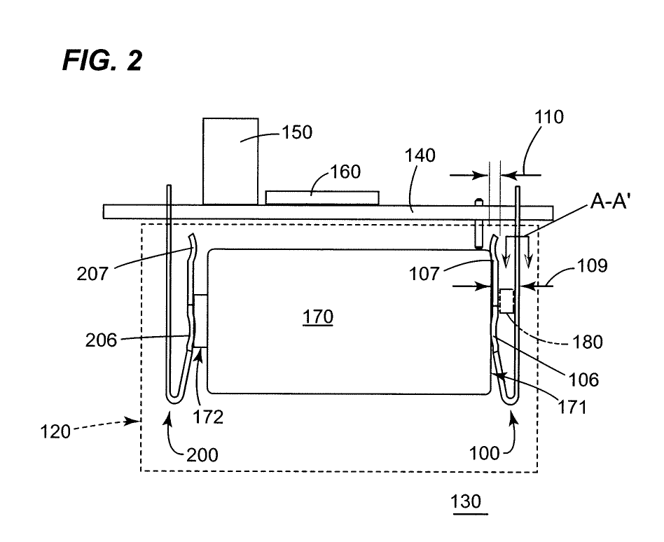

FIG. 1 is a diagram showing a first position of an embodiment of a battery clip 100 when a battery is moved relative to a battery compartment 120 of an electronic device 130. For a battery clip 100 embodied as illustrated in FIG. 1, the battery clip 100 is configured to reset the electronic device 130 when the battery 170 (shown in FIG. 2) is removed from the battery compartment 120. In an alternate embodiment, described below, the battery clip 100 is configured to reset the electronic device 130 when the battery 170 is inserted into the battery compartment 120.

The battery compartment 120 can be an area configured to receive one or more removable batteries (170 in FIG. 2). The battery compartment 120 may or may not be enclosed on one or more sides. The battery compartment (120) may be included in, or coupled with, the electronic device (130).

The electronic device 130 may include a microprocessor 160, a reset pin 141, and one or more components 150 coupled with, formed on, or attached to, a printed circuit board 140. The one or more components 150 may include, but are not limited to, one or more capacitors configured to store residual battery energy provided by one or more batteries (170 in FIG. 2) when the one or more batteries are inserted within the battery compartment 120. The microprocessor 160 may be coupled with the one or more capacitors to draw stored residual battery energy therefrom. The printed circuit board 140 may include circuitry 142 that is coupled to an electrical ground. For convenience, the circuitry 142 may hereinafter be referred to as a “ground circuit 142” or as “ground 142”. As will be further explained below, the reset pin 141 may also be coupled with the one or more capacitors 150.

Referring to FIG. 1, an embodiment of the battery clip 100 may have a fixed end 101, a curved portion 102, and a free end 103. The fixed end 101 of the battery clip 100 may be coupled with the ground circuit 142 that forms part of printed circuit board 140. Any suitable means for coupling the fixed end 101 of the battery clip 100 with the ground circuit 142 may be used. One non-limiting example of a means for coupling includes an electrically conductive receptacle formed in the printed circuit board 140 into which the fixed end 101 of the battery clip 100 is inserted. Another non-limiting example of a means for coupling includes an electrically conductive pad (not shown) formed as part of, or attached to, the printed circuit board 140. The fixed end 101 of the battery clip 100 may be directly connected to the electrically conductive pad. Alternatively, an electrically conductive trace or wire may be used to couple a portion of the battery clip 100 with the electrically conductive pad.

A first segment 104 of the battery clip 100 may extend between, and/or include, the fixed end 101 and a portion of the curved portion 102. A second segment 105 of the battery clip 100 may extend between, and/or include, another portion of the curved portion 102 and the free end 103.

The first segment 104 may be linear; and the second segment 105 may include one or more curvilinear portions. One such curvilinear portion may be a first connector 106 disposed between the curved portion 102 and the free end 103 of the battery clip 100. The first connector 106 may be a battery terminal connector. The first connector 106 is a non-limiting example of a means for coupling the battery clip 100 with a terminal (171 in FIG. 2) of a battery (170 in FIG. 2). The first connector 106 may have a bend, or apex, configured to engage a terminal (171 in FIG. 2) of a battery (170 in FIG. 2), when the battery is inserted within the battery compartment 120 of the electronic device 130. Another curvilinear portion may be a second connector 107 disposed at or proximate the free end 103 of the battery clip 100. The second connector 107 may be a pin connector. The second connector 107 is a non-limiting example of a means for coupling the battery clip 100 with the reset pin 141. The second connector 107 may have a bend, or apex, configured to engage a portion of the reset pin 141, when the battery is removed from, or is removed from, moved relative to the battery compartment 120 of the electronic device 130. When the second connector 107 contacts the reset pin 141, the second segment 105 of the battery clip 100 may be separated from the first segment 104 of the battery clip 100 by a first distance 108. Movement of the battery 170 relative to the battery compartment 120 occurs when the battery 170 is either inserted into the battery compartment 120 or is removed from the battery compartment 120.

An embodiment of the battery clip 100 may include a means for actuating the battery clip 100—or a portion thereof—to contact the reset pin 141 when the battery is removed from the battery compartment 120. The means for actuating the battery clip 100 may be disposed between the fixed end 101 and the free end 103 of the battery clip 100.

A non-limiting example of the means for actuating is the curved portion 102. The curved portion 102, combined with the biasing characteristics of the material(s) that form the battery clip 100, may provide a biasing force that urges the free end 103 of the battery clip 100 towards the reset pin 141. In another embodiment, a non-limiting example of a means for actuating is an actuator 180. The actuator 180 may function to apply a pushing force or a pulling force that urges the free end 103 of the battery clip 100 towards the reset pin 141. In one embodiment, the actuator 180 may be a spring. A “spring” is an elastic device, formed of any suitable material(s), that returns to its original shape when pushed, pulled, or pressed. Thus, both the curved portion 102 and the actuator 180—individually or in combination—are examples of the means for actuating the battery clip 100—or a portion thereof—to contact the reset pin 141.

Referring still to FIG. 1 an operation of the battery clip 100 is described. To begin, when a battery (170 in FIG. 2) is absent from—or as the battery 170 is removed from—the battery compartment 120, the free end 103 of the battery clip 100 is urged by a biasing force to connect the second connector 107 with a portion of the reset pin 141. A “biasing force” is a force that moves the free end 103 of the battery clip in a predetermined direction—e.g. either toward or away from the reset pin 141—and which is overcome by inserting or moving the battery 170 relative to the battery compartment 120. As a result, residual battery energy—e.g., electrical charge—stored in the one or more capacitors, which may form part of the one or more components 150, flows through the battery clip 100 and the ground circuit 142 to an electrical ground. Once the residual battery energy is dissipated from the one or more capacitors 150, the microprocessor 160—or at least one of an operating state or a function of the microprocessor 160 that necessitated removal of the battery (170)—is reset.

FIG. 2 is a diagram showing a second position of the embodiment of the battery clip 100 of FIG. 1 when the battery 170 is inserted within the battery compartment 120. Referring to FIG. 2, another operation of the battery clip 100 is described. To begin, when the battery 170 is in the battery compartment 120, or as the battery 170 is inserted into the battery compartment 120, a terminal 171 of the battery 170 urges the free end 103 of the battery clip 100 to overcome the biasing force and to move away from the reset pin 141 by a predetermined distance 110. As a result, residual battery energy—e.g., electrical charge—is stored in the one or more capacitors, which may form part of the one or more components 150, for later use by the microprocessor 160. The battery terminal 171 may be a negative (−) terminal. When the second connector 107 does not contact the reset pin 141, the second segment 105 of the battery clip 100 may be separated from the first segment 104 of the battery clip 100 by a second distance 109. The second distance 109 may be less than the first distance 108, referenced above.

As further illustrated in FIGS. 1 and 2, another terminal 172 of the battery 170 may engage another battery connector 206 of a second battery clip 200. The second battery clip 200 may be identical to the battery clip 100 in materials and/or operation. In one embodiment, a pin connector 207 may be configured to connect with a second reset pin (not shown). Alternatively, as shown except that in the embodiment shown of in FIGS. 1 and 2, the pin connector 207 may have no reset pin to connect with. The another terminal 172 of the battery 170 may be a positive (+) terminal.

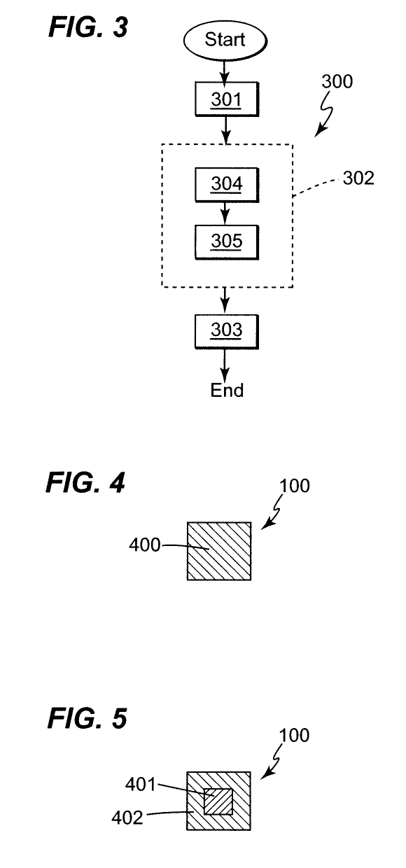

FIG. 3 is a flowchart illustrating an embodiment of a method 300 of removing a battery to automatically reset an electronic device 130 (FIG. 1). Referring to FIGS. 1, 2, and 3, the flowchart in FIG. 3 includes one or more functional blocks that represent individual functions—or actions—that a user of the electronic device 130 may perform—or cause to be performed—to reset the electronic device 130. Unless otherwise noted, the functions represented by the functional blocks 301, 302, 303, 304, and 305 may be performed individually, simultaneously, or in any suitable combination.

Referring now to FIGS. 1, 2, and 3, an embodiment of the method 300 may include, as represented by functional block 301, moving the battery 170 relative to a battery compartment 120. Moving the battery 170 relative to the battery compartment includes one of removing the battery 170 from the battery compartment 120 and inserting the battery 170 into the battery compartment 120. The battery compartment 120 may be included in, or coupled with, an electronic device 130. As represented by functional block 302, the method 300 may further include actuating a battery clip 100. As represented by functional block 303, the method 300 may further include resetting an electronic device 130. As described above, resetting an electronic device 130 may include dissipating residual battery energy from one or more capacitors 150 that are coupled with a reset pin 141. Resetting an electronic device 130 may further include resetting a microprocessor 160 of the electronic device 130—or at least one of an operating state and a function of a microprocessor 160 that necessitated replacement of one or more batteries 170 from the battery compartment 120.

The functional block 302 may further include other functions. For example, as represented by functional bock 303, the resetting function represented by the functional block 302 may further include contacting a battery clip 100—or a portion 103, 107 thereof—to a portion of a reset pin 141. As represented by functional block 304, the resetting function represented by the functional block 302 may further include shorting the reset pin 141—and one or more capacitors 150 coupled thereto—to a ground circuit 142.

FIG. 4 is a cross-sectional view, taken along the line A-A′ in FIG. 2, of a material 400 that comprises an embodiment of the battery clip 100. In an embodiment, the material 400 is electrically conductive. In another embodiment the material 400 is both electrically conductive and non-corrosive. FIG. 5 is also a cross-sectional view, taken along the line A-A′ in FIG. 2, of a material 401, which is electrically conductive and plated with a non-corrosive material 402, that comprises another embodiment of the battery clip 100. The non-corrosive material 402 may also be electrically conductive.

Referring to FIGS. 1, 4, and 5, the battery clip 100 may be formed of one or more pieces of an extruded, electrically conductive material 400, 401, non-limiting examples of which may include: metal, metal alloys, and combinations thereof. The electrically conductive material(s) that form the battery clip 100 may be naturally non-corrosive or may be treated to be non-corrosive. An embodiment of the battery clip 100 may comprise an electrically conductive material 400 that is non-corrosive. A non-limiting example of an electrically conductive material 400 that is non-corrosive is beryllium copper.

As shown in FIG. 5, an embodiment of the battery clip 100 may comprise an electrically conductive material 401 that is plated with a non-corrosive material 402. By way of example, the electrically conductive material 401 may be beryllium copper or copper; and the non-corrosive material 402 may be tin.

Alternate embodiments of the claimed invention are also contemplated. For example, a battery compartment 120, configured to hold multiple batteries, may include a battery clip 100 and a reset pin 141 for each of the multiple batteries. In such an embodiment, a user may be required to install all of the multiple batteries for the electronic device 130 to operate. Thus, in this embodiment, or the embodiment described with reference to FIGS. 1 and 2, the battery clip 100 prevents the user from bypassing a re-initialization of the electronic device 130 when it is time to replace the battery or batteries.

The embodiment of the battery clip 100 shown in FIGS. 1 and 2 is configured to short out the reset pin 141 to ground—e.g., to an active low; however, in other embodiments, the reset pin 141 may be shorted to whatever type of connection that a manufacturer—and/or installer—of the battery clip 100 wants to make, such as activating a circuit momentarily. Examples of such a circuit include, but are not limited to a watchdog circuit, or other type of reset circuit, which was briefly referenced above.

Additionally, as previously noted, the battery clip 100 may be configured, in an alternate embodiment, to operate in a manner reverse to that described above with respect to FIG. 1. In particular, the reset pin 141 can be moved to an opposite side of the free end 103 of the battery clip 100. In this alternate embodiment, the free end 103 contacts the reset pin 141 when a battery 170 occupies or is inserted into the battery compartment 120, and breaks contact with the reset pin 141 when the battery 170 is not present in, or is removed from, the battery compartment 120. In this alternate embodiment, a watchdog circuit, or other type of reset circuit, coupled with the reset pin 141 can be configured to drain residual battery energy from the one or more capacitors 150 when the free end 103 of the battery clip 100 breaks contact with the reset pin 141.

In yet another embodiment, the operation of the battery clip 200 may also be modified. For example, when a battery 170 is inserted between the battery clips 100 and 200, the free end 207 of the battery clip 200 shown in FIGS. 1 and 2 may connect a pin (not shown, but which may be an equivalent of the reset pin 141) to a circuit (not shown) that turns on a transistor, which activates a watchdog circuit, or other type of reset circuit, to reset the electrical device 130.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Accordingly, these and other modifications are intended to be included within the scope of the appended claims.

1. A battery clip, comprising:
a fixed end;
a free end; and
means for actuating the battery clip to reset an electronic device when a battery is moved relative to a battery compartment, the means for actuating disposed between the fixed end and the free end of the battery clip.

2. The battery clip of claim 1, wherein the movement of the battery relative to the battery compartment includes removing the battery from the battery compartment.

3. The battery clip of claim 1, further comprising:
means for coupling the battery clip with a terminal of the battery; and
means for coupling the battery clip with a reset pin that is coupled with the one or more capacitors.

4. The battery clip of claim 1, wherein the fixed end is configured to couple with a ground circuit of the electronic device.

5. The battery clip of claim 1, wherein the electronic device is a smoke detector.

6. The battery clip of claim 1, wherein the battery clip comprises an electrically conductive material that is non-corrosive.

7. The battery clip of claim 1, wherein the battery clip comprises an electrically conductive material plated with a non-corrosive material.

8. A battery clip, comprising:
a fixed end;
a free end;
a curved portion disposed between the fixed end and the free end; and
a first connector disposed between the curved portion and the free end; and
a second connector disposed proximate the free end and configured to contact a reset pin to dissipate residual battery energy from one or more capacitors coupled with the reset pin when a battery is moved relative to a battery compartment.

9. The battery clip of claim 8, wherein the second connector disposed proximate the free end is configured to contact a reset pin to dissipate residual battery energy from the one or more capacitors coupled with the reset pin when the battery is removed from the battery compartment.

10. The battery clip of claim 8, wherein the fixed end is configured to couple with a ground circuit of an electronic device

11. The battery clip of claim 8, wherein the first connector is configured to contact a terminal of the battery.

12. The battery clip of claim 11, wherein the terminal is a negative (−) terminal of the battery.

13. The battery clip of claim 8, wherein the battery clip is configured to reset an electronic device when the battery is moved relative to the battery compartment.

14. A method, comprising:
moving a battery relative to a battery compartment of an electronic device;
actuating a battery clip as a result of the moving; and
dissipating residual battery energy to reset the electronic device.

15. The method of claim 14, wherein the moving includes one of removing the battery from the battery compartment and inserting the battery into the battery compartment.

16. The method of claim 14, wherein the actuating a battery clip further comprises:
contacting the battery clip to a reset pin; and
shorting the reset pin, and one or more capacitors coupled with the reset pin to a ground circuit.

17. The method of claim 14, wherein the device is a smoke detector.

18. An electronic device, comprising:
a battery clip configured to reset the electronic device when a battery is moved relative to a battery compartment.

19. The electronic device of claim 18, wherein the battery clip is configured to reset the electronic device when the battery is removed from the battery compartment.

20. The electronic device of claim 18, wherein the battery compartment is included in the electronic device.

21. The electronic device of claim 18, wherein the battery compartment is coupled with the electronic device.

22. The electronic device of claim 18, wherein the electronic device is a smoke detector.

23. (canceled)

24. The electronic device of claim 18, wherein the battery clip comprises an electrically conductive material that is plated with a non-corrosive material.

25. The electronic device of claim 24, wherein the electrically conductive material is one of beryllium copper or copper, and wherein the non-corrosive material is tin.

26. The electronic device of claim 18, wherein the battery clip comprises an electrically conductive material that is non-corrosive.
